(19) United States
(12) Patent Application Publication
(10) Pub. No.: US 2025/0093098 A1
(43) Pub. Date: Mar. 20, 2025

(54) APPARATUS FOR DEVOLATIZING SOLIDS AT LOW TEMPERATURES

(71) Applicant: INDUSTRIAL FURNACE SERVICE HUB, LLC, Brookpark, OH (US)

(72) Inventors: James M JABLONOWSKI, Seven Hills, OH (US); Joseph M JABLONOWSKI, Seven Hills, OH (US); Alan M JABLONOWSKI, Medina, OH (US)

(73) Assignee: Industrial Furnace Service Hub LLC, Brook Park, OH (US)

(21) Appl. No.: 18/729,339

(22) PCT Filed: Apr. 28, 2023
(86) PCT No.: PCT/US2023/066337

§ 371 Date: Jul. 16, 2024

Related U.S. Application Data
(60) Provisional application No. 63/336,373, filed on Apr. 29, 2022.

(51) Int. Cl. F26B 21/04; F26B 21/00; F26B 23/00

(52) U.S. Cl. CPC F26B 21/04; F26B 21/004; F26B 23/00

(57) ABSTRACT

An apparatus and process for removing volatiles from a solid at a low temperature, preferably below the boiling point of the volatile at standard temperature and pressure based upon the principle of not re-using the exhaust gas. The devolatilization can occur using a belt, a cyclone, a perforated plate or rotating chamber. This permits the preservation of products that would be harmed at temperatures above the boiling point.

### CROSS REFERENCES AND PRIORITIES

This application claims priority from U.S. Provisional Application No. 63/336,373 filed on 29 Apr. 2022, the teaching of which are incorporated by reference herein in their entirety.

### BACKGROUND

The art and literature are replete with publications about “drying” solids, which is the removal of moisture from the solid.

One typical method to dewater solids, is to press the solids to release liquid water from the solids.

Another method is to heat the solids to convert the water to vapor (steam) and then remove the steam from around the solids. The vapor (steam) is removed from around the solids by passing a gas or mixture of gasses, such as air, over the solids.

To conserve the heat used to heat the gas, prior art systems recirculate the heated gas (air) containing the removed volatile(s) with only some amount of the heated gas (air) being purged, i.e. exhausted out of the re-circulation loop and replaced with fresh air which is to be heated.

U.S. Pat. No. 10,634,429 to Lateen et al. is one such system. Latein teaches that energy is of course needed for heating the [fresh] air to hot air. According to Latein, this energy is lost when the hot air generated is discharged into the surroundings after the drying of the material. First steps for circulating the hot air are therefore known.

Latein's invention is also directed to a method for operating a continuous flow dryer for drying a material by means of hot air, wherein fresh air is supplied as supply air, exhaust air is removed and recirculated as supply air, and by means of a heat exchanger waste heat of the exhaust air is transferred into the fresh air. According to Latein, a partial amount of the exhaust air is completely removed from the continuous-flow dryer.

Latein further teaches to pass the exhausted air to the heat exchanger striking a separating surface where the heat exchanges from the exhaust air to the fresh air, while at the same time water condenses out of the exhaust air and re-enters the housing to remove more moisture.

### SUMMARY

This specification discloses an apparatus and process for devolatilizing solids below the boiling point of the volatile.

The apparatus described has a devolatilization chamber with a devolatilization chamber volume, a devolatilization chamber first end, a devolatilization chamber second end opposite the devolatilization chamber first end, a devolatilization chamber length, a devolatilization chamber wall encompassing the devolatilization chamber volume defined by the devolatilization chamber wall, the devolatilization chamber first end and the devolatilization chamber second end.

It is further disclosed that the devolatilization chamber has a devolatilization chamber solids feed inlet at the devolatilization chamber first end and a devolatilization chamber solids discharge outlet at the devolatilization chamber second end.

It is further disclosed that the apparatus has a first distribution chamber with a first distribution chamber inlet at the devolatilization chamber first end which is fluidly connected to the first distribution chamber located in the devolatilization chamber volume. This first distribution chamber is further fluidly connected to a first distribution chamber outlet located at the devolatilization chamber second end with the first distribution chamber having at least one first distribution chamber port for a heated gas to pass from the first distribution chamber into the devolatilization chamber where the heated gas becomes a process gas to devolatilize the solids passing through the devolatilization chamber.

It is further disclosed that this heated gas is heated in a heat chamber. This heat chamber has a heat chamber volume housing a heat source and has a feed gas inlet into the heat chamber volume, a heated gas outlet and a recirculated gas inlet.

It is further disclosed that the apparatus has a motivation device, such as a fan to move the gas through the fluidly connected unit operations of the apparatus. In particular, the motivation device creates a pressure differential and removes the heated gas from the heat chamber to the distribution chamber inlet. This motivating force may be located at the feed gas inlet to force a feed gas into the heat chamber to replenish the exhaust gas exiting the apparatus, wherein the motivating force is sufficient to move a gas throughout the apparatus.

The apparatus is constructed so that the heated gas outlet is fluidly connected with the first distribution chamber inlet, and the first distribution chamber outlet is fluidly connected with the recirculated gas inlet.

It is further disclosed that the devolatilization chamber wall can have a plurality of perforations and is housed inside a process chamber. The process chamber will have at least one exhaust outlet for the process gas containing the volatile(s) from the solids to rise from the devolatilization chamber as an exhaust gas.

The apparatus described herein can have a catch pan located beneath the devolatilization chamber to collect and remove at least one liquid that may drip from the solids and/or a plurality of particles that may fall from the devolatilization chamber.

It is further disclosed that the devolatilization chamber may or may not rotate about its longitudinal axis and the devolatilization chamber may or may not be inclined relative to the force of gravity.

This specification further discloses that there may be a cover over the distribution chamber catch pan to prevent solids from entering the distribution chamber

It is further disclosed that the devolatilization chamber wall may be configured to advance a solid in the devolatilization chamber volume along the length of the devolatilization chamber while the devolatilization chamber is rotating. The specification discloses that this configuration could be flights extending from the devolatilization chamber wall into the devolatilization chamber. These flights may have paddles between them to lift the solids while rotating.

It is further disclosed that the apparatus may have a second distribution chamber inlet at the devolatilization chamber first end which is fluidly connected to a second distribution chamber. This second distribution chamber is not located in the devolatilization chamber volume, but is located within the process chamber. This second distribution chamber has at least one second distribution chamber port for the heated gas to pass from the second distribution chamber. It is also disclosed that the heated gas outlet may be fluidly connected with the second distribution chamber inlet.

It is also disclosed that the second distribution chamber may not be fluidly connected with the recirculated gas inlet.

### BRIEF DESCRIPTION OF FIGURES

FIG. 1 is a front view and unit flow diagram of an embodiment of the apparatus.

FIG. 2 is a cut away side view of the apparatus.

FIG. 3 is a front view and unit flow diagram of an alternate embodiment of the apparatus.

FIG. 4 is a front view and unit flow diagram of another alternate embodiment of the apparatus.

FIG. 5 is a front view and unit flow diagram of another alternate embodiment of the apparatus.

FIG. 6 is a front view and unit flow diagram of another alternate embodiment of the apparatus.

### DETAILED DESCRIPTION

This specification discloses an apparatus for devolatizing solids (removing volatiles from a solid) at low temperatures. The apparatus is described below with reference to the Figures. As described herein and in the claims, the following numbers refer to the following structures as noted in the Figures.

10 is an apparatus of the invention.

100 is a devolatilization chamber.

110 is a devolatilization chamber volume.

120 is a devolatilization chamber first end.

130 is a devolatilization chamber second end.

140 is a devolatilization chamber length.

150 is a devolatilization chamber wall.

160 is a devolatilization chamber solids feed inlet.

170 is a devolatilization chamber solids discharge outlet.

180 are perforations in the devolatilization chamber wall.

190 are flights extending from the devolatilization chamber wall into the devolatilization chamber volume that advance the solids along the devolatilization chamber.

195 are paddles between the flights.

196 is a belt that advances the solids along the devolatilization chamber.

197 is a perforated plate that in combination with the heated gas advances the solids along the devolatilization chamber.

198 is Fg which is the force of gravity.

200 is a first distribution chamber.

210 is a first distribution chamber inlet.

220 is a first distribution chamber outlet.

230 is a first distribution chamber port.

240 is a cover over the first distribution chamber.

300 is a heat chamber.

310 is a heat chamber volume.

320 is a heat source.

330 is a feed gas inlet.

340 is a heated gas outlet.

350 is a recirculated gas inlet.

400 is a motivation device.

500 is a process chamber.

510 is an exhaust outlet.

510A is an exhaust outlet.

510B is an exhaust outlet.

520 is a catch pan.

600 is a second distribution chamber.

610 is a second distribution chamber inlet.

630 is a second distribution chamber port.

700 is a heated gas.

800 is a process gas.

850 is an exhaust gas.

850A is an exhaust gas.

850B is an exhaust gas.

900 is a feed gas.

950 is a recirculation gas.

1000 is a liquid.

1100 is a motor, a mechanical device to rotate the devolatilization chamber.

1110 is a chain connecting a gear driven by the motor with a gear on the devolatilization chamber.

1130 are fasteners, such as bolts.

1140 is a mounting plate.

1150 are drum rollers.

1200 is a second process chamber.

1300 is a second devolatilization chamber.

This invention is to the devolatilization of solids using a low temperature gas. The primary principle of operation is removal of a volatile(s) based upon their partial pressure with a process gas which is the gas that is being passed over or through the solids in a devolatilization chamber, which, in the case where the volatile is water, the devolatilization chamber is known as a drying chamber.

A volatile is a substance which has a gauge vapor pressure greater than 0 at standard temperature and pressure (STP). A volatile could be organic or in-organic. The volatile's boiling point is not so relevant as it is known that a volatile could be entrained in the solids and that passing a gas without the volatile over, or through, the solids will remove the volatile from the solids.

As discussed in the background section the prior art does not rely solely on partial pressure difference of the volatile in the solids and the gas, but upon heating the gas to create a heated gas to further drive the volatile off the solids. This is done to increase the amount of the volatile that is released from the solids into the process gas with the volatile thus taken away from the solids.

According to conventional wisdom and sound engineering principles, the prior art processes conserve heat and recirculate the process gas containing the removed volatile with only a portion of the process gas being removed from the apparatus as an exhaust gas or purge gas. The exhaust gas is then replaced by a feed gas which has less than the saturation amount of the volatile, preferably none of the volatile is present in the feed gas.

The difficulty with this prior art system is that the recirculating process gas becomes saturated with the volatile and the amount of volatile being removed over time is equal to the amount of volatile saturated in the exhaust gas. Because heat is conserved, the “apparent solution” is to increase the temperature even further to increase the saturation level of exhaust gas or cool the gas to remove some to the volatile via condensation.

This prior art process is problematic in that in many instances, the high temperatures can damage the volatile if the volatile is the desired product and/or the high temperatures can damage the solids. Such is the case with fragrance producing agricultural products and cannabis, respectively.

Non-limiting examples of solids suitable for devolatilization are sewage sludge, wood fuel products such as chips, shavings, bark, sawdust or hogged wood (which is any wood by-product or waste that can burned as fuel but can't be categorized as chips, shavings, bark, or sawdust), RDF (refuse derived fuel), SSW (solid shredded waste), MSW (municipal solid waste), household waste, grass, and agricultural products and by-products such corn stover and sugar beet pulp.

Additional examples of solids benefitting from the process include manufactured articles that use a liquid in the manufacturing process and wish to have it removed, such as painted parts or coated parts or lubricant oils.

One principle of operation of the described apparatus is that the process gas containing the removed volatile is not recirculated back into the process and/or does not come in further contact with the solids. In this manner, the process gas doing the devolatilization has none of the volatile vapors and places the greatest driving force based upon partial pressure of the volatile compound. While no recirculation of the volatile contaminated process gas and 100% purging of the process gas is most preferred, it is possible to achieve better results when only 50% by volume of the process gas is purged or exhausted and 50% is recirculated.

Accordingly, the relative volume of the process gas containing the removed solids to be exhausted should be in at least one of the ranges of 50 to 100%, 60 to 100%, 75 to 100%, 90 to 100%, and 95 to 100%.

It is noted that it is not necessary that the feed gas be free of the volatile.

In this manner the temperature of the process gas can be low, such as below the boiling point of the volatile at STP.

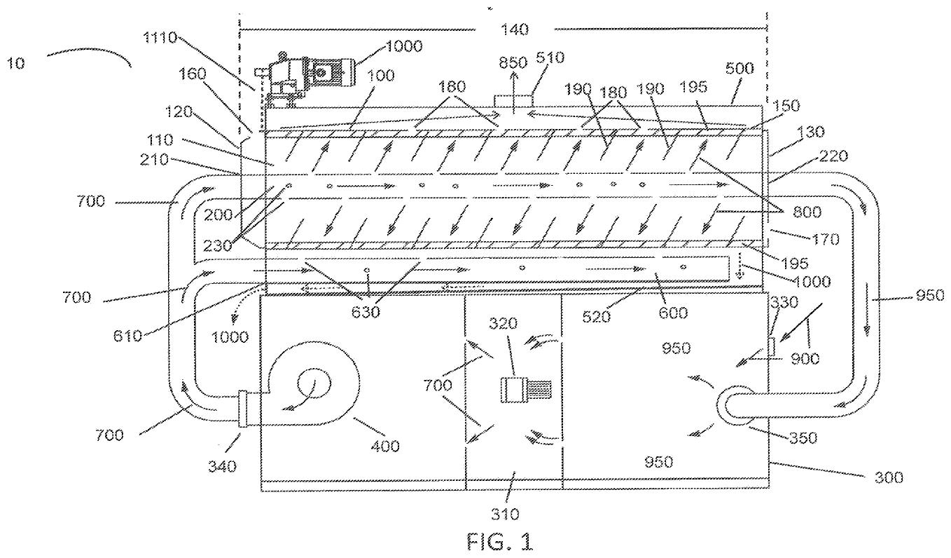

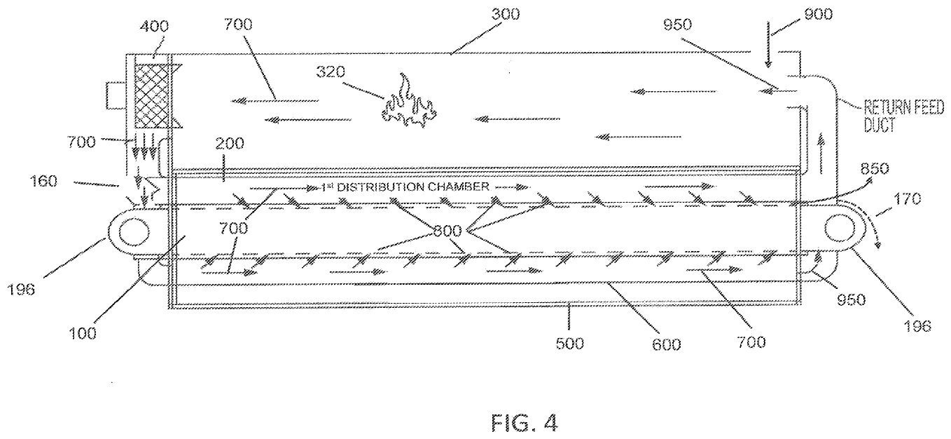

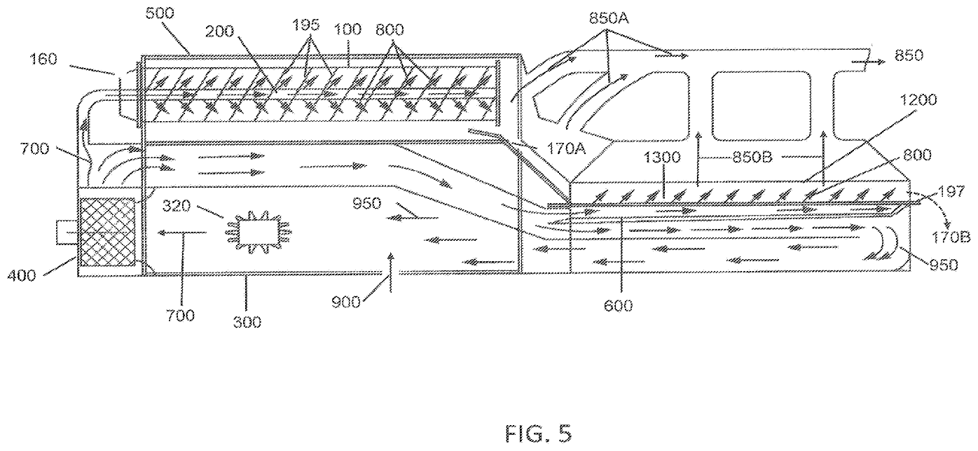

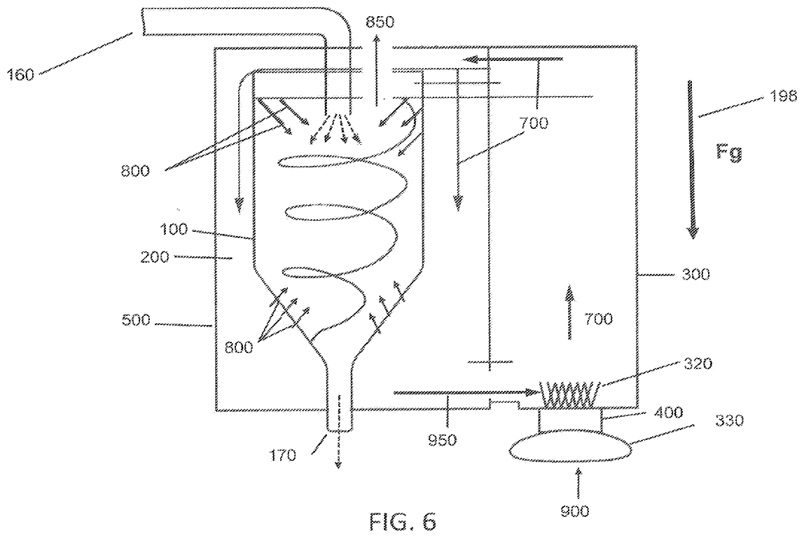

The various unit operations of the apparatus are a feed gas inlet (330) and a recirculated gas inlet (350) entering a heat chamber (300). The heat chamber transfers heat (320) into the feed gas. The heat could be indirect heat via a heat exchanger or direct heat such as an electrical element or a combustion gas. A motivating force (400), such as a fan, circulates the heated gas into at least one distribution device (200) located in a devolatilization chamber (100) which distributes the heated gas into the devolatilization chamber. The solids to be devolatilized enter one end of the devolatilization chamber and there is solid advancement force (e.g. 195, 196, 197, 198) which moves (advances) the solids through the devolatilization chamber. Types of advancement device are a rotating screw or drum (FIGS. 1, 2, 3, and 5), a belt (FIG. 4), a perforated plate (197) with heated gas entering at an angle (FIG. 5), and gravity (198) (FIG. 6). One advancement force not shown is a pulsing bed where heated gas is pulsed at an advancement angle into a layer of the solids on a perforated plate. The pulse lifts the solids and pushes through the chamber. There are typically multiple pulses in sequence that keep the solid “fluidized” as it advances down the chamber. Another advancement force not shown is that provided by a “walking” or moving floor where the slats of the floor advance, and then pull back pushing the solids along the path. The process gas (800) absorbs the volatile and is then exhausted (850) away from the solids. The heated gas which does not enter the devolatilization chamber is recirculated (950).

Referring to FIG. 1, the apparatus (10) operates as described below with the solid arrows (e.g. 700) showing the directions of gas flow. Because the gas flow direction is depicted with arrows, the lines from the element number to the element do not have arrows. The solid arrows are gas and the dashed arrows are non-vapor/non-gas such as solids, or liquids which could have entrained solids as well.

The feed gas (900) enters the heat chamber (300) through feed gas inlet (330). The feed gas is preferably void of the volatile of interest. The phrase volatile-free means that the gas does not have any of the volatile of interest. It does not mean that the feed gas is void of all volatiles.

The heat chamber has a heat chamber volume (310) and houses a heat source (320). The heat source could be direct heat or indirect heat (i.e. a heat exchanger) with the heat generated by any of the known techniques such of direct fuel combustion, electric, steam (using a heat exchanger), or the like. The purpose of the heat source is to heat the gas in the heat chamber. As shown in FIG. 1, the gas which is heated is preferably a mixture of the recirculated gas (950) and the feed gas (900).

The heated, or hot, gas passes from the heat chamber through a heated gas outlet (340).

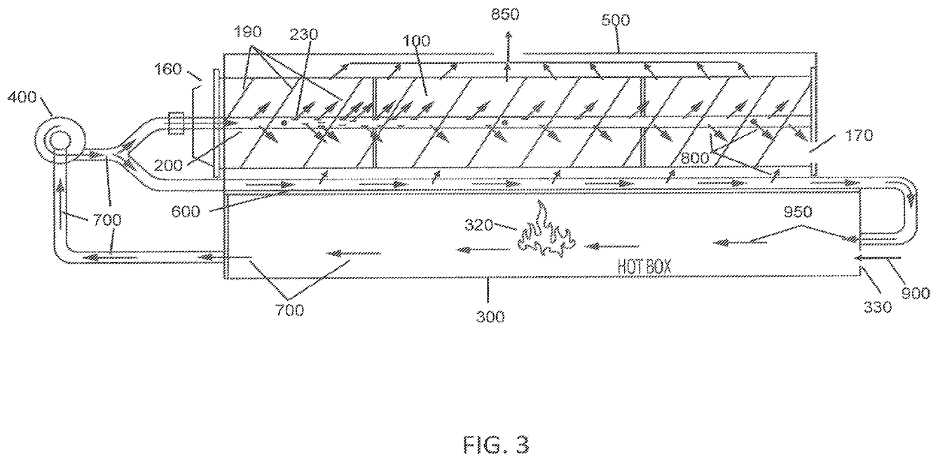

The force moving the heated gas from the heat chamber is created by a motivation device (400) such as fan or a blower. While shown in FIG. 1 as being located inside the heat chamber located at the heat chamber outlet, the motivation device could be located outside the heat chamber with the heat chamber outlet fluidly connected to a fan inlet which pulls the hot gas out of the heat chamber and pushes it further through the apparatus (FIG. 3). Alternatively the fan/blower could be located at the entrance of the feed gas into the heating chamber (FIG. 6).

Once the hot gas leaves the heat chamber it becomes a heated gas (700).

The heat chamber outlet is fluidly connected to at least a first distribution chamber inlet (210) which is fluidly connected with at least a first distribution chamber (200).

The heated gas flows through the first distribution chamber. The first distribution chamber has a plurality of first chamber distribution ports (230) which could be holes, perforations, slots, slits, or any opening which allows at least a portion of the heated gas to escape from the distribution chamber and contact the solids which are located in a devolatilization chamber (100). Once the heated gas passes into the devolatilization chamber it becomes a process gas (800).

The first distribution chamber has a first distribution chamber outlet (220) which is fluidly connected to the recirculated gas inlet (350) of the heat chamber. Any of the heated gas passing through the first distribution chamber outlet, which, as shown in FIG. 1, has not contacted the solids, becomes a recirculated gas and re-enters the heat chamber through the recirculated gas inlet.

It is preferable that none of the gas which was once a process gas containing the volatile(s) enters the heat chamber. In this manner, the process gas passing over the solids has the highest capacity and driving force to remove the volatile(s) from the solids. By highest driving force, it is meant the greatest pressure difference between the vapor pressure of the volatile(s) at the devolatilization chamber conditions (primarily temperature) and the partial pressure of the volatile(s) in the process gas, which is preferably O because the process gas is preferably volatile-free. Should the heated gas have any of the volatile(s) the pressure difference (driving force) will decrease.

As shown in all the embodiments of FIGS. 1 to 6, there is no fluid connection between the exhaust, the heat chamber, or the process chamber and the devolatilization chamber. In this manner the exhaust gas containing the removed volatiles is not recirculated into the devolatilization chamber.

While it is preferred, and shown in the embodiments of FIGS. 1 to 6, that none of the gas which was once a process gas containing the volatile(s) enters the heat chamber, embodiments may exist where a small portion of the gas which was once a process gas containing the volatile(s) may enter the heat chamber. In such embodiments, it is preferred that no more than 50.0% by volume of the gas which was once process gas containing the volatile(s) enters the heat chamber, with no more than 5.0% by volume of the gas which was once process gas containing the volatile(s) entering the heat chamber being more preferred, no more than 2.5% by volume of the gas which was once process gas containing the volatile(s) entering the heat chamber being still more preferred, and no more than 1.0% by volume of the gas which was once process gas containing the volatile(s) entering the heat chamber still more preferred with no more than 0.5% by volume of the gas which was once process gas containing the volatile(s) entering the heat chamber being most preferred.

FIG. 1 also depicts a second distribution chamber (600) with a second distribution chamber inlet (610) and a plurality of second distribution chamber perforations (650) to allow the heated gas to flow out of the second distribution chamber to become a process gas and contact the solids. It is noted that the embodiment in FIG. 1 shows all of the heated gas entering the second distribution chamber flows through the second distribution chamber perforation(s) and becomes process gas as there is no second chamber distribution outlet. However, a different embodiment as shown in FIG. 5 can recirculate the gas which has not passed through the second distribution perforations by fluidly connecting the second distribution chamber with the recirculation system or otherwise having the gas pass into the heat chamber.

The location of the first and second distribution chambers is not relevant, provided that the gas passing through the perforations can contact the solids. In this embodiment, the first distribution chamber is located inside the devolatilization chamber in the devolatilization chamber volume (110) while the second distribution chamber is outside of the devolatilization chamber volume.

The devolatilization chamber will have a devolatilization chamber first end (120) and a devolatilization chamber second end (130) opposite the devolatilization chamber first end. There will be a devolatilization chamber length (140) which is the distance from the devolatilization chamber first end to the devolatilization chamber second end.

There will be a devolatilization chamber wall (150) encompassing the devolatilization chamber volume defined by the devolatilization chamber wall which preferably has the devolatilization chamber first end and the devolatilization chamber second end.

There will be a devolatilization chamber solids feed inlet (160) at the devolatilization chamber first end for feeding the solids into the devolatilization chamber, and a devolatilization chamber solids discharge outlet (170) at the devolatilization chamber second end.

The devolatilization chamber wall preferably has a plurality of perforations (180) and is housed inside a process chamber (500) with the process chamber having at least one exhaust outlet (510) for the process gas to rise from the devolatilization chamber as an exhaust gas (850) containing the volatile(s) to be collected and further treated. The housing may also have a catch pan (520) to collect and remove at least one liquid (1000) and any plurality of particles falling from the devolatilization chamber through the perforations.

In the embodiment of FIG. 1, the devolatilization chamber rotates about a longitudinal axis which means there is also some mechanical device (1100) causing the devolatilization chamber to rotate. However, a rotating and non-rotating devolatilization chamber are proposed. In this embodiment in FIG. 1 the mechanical device is a motor driving a chain (1110) which may also be a belt. Alternatively, the motor could directly rotate the devolatilization chamber via a gear box.

In some embodiments the devolatilization chamber wall has a configuration to advance a solid into the devolatilization chamber volume along the length of the devolatilization chamber while the devolatilization chamber is rotating. An example of this type of configuration is flights (190) extending from the devolatilization chamber wall into the devolatilization chamber. The devolatilization chamber may also have paddles between the flights (195). As the devolatilization chamber rotates, the solids advance along the length of the devolatilization chamber due to the augering of the flights. The paddles between the flights lift the solids from the bottom of the chamber and drop the solids through the process gas, thus increasing the area of contact between the solids and the process gas.

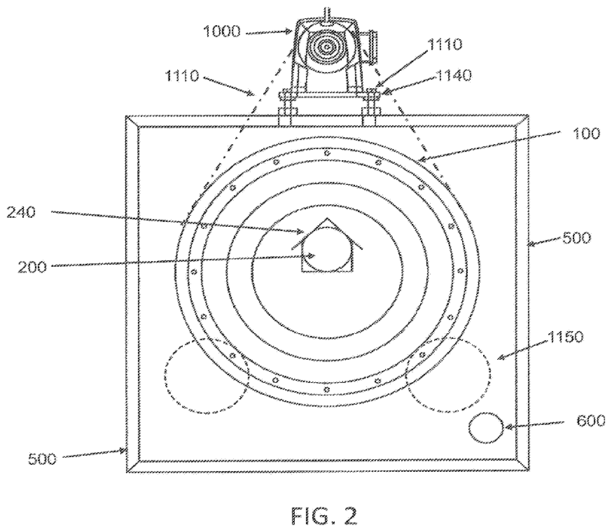

Also, as shown in FIG. 2, the first distribution chamber may have a cover on the side opposite the catch pan. This is to prevent any of the solids or liquids from dropping onto, or into, the first distribution chamber.

FIGS. 3-6 depict other embodiments having the same principle of operation.

FIG. 3 is similar to the embodiment in FIGS. 1 and 2, but with the motivation force (400) outside the heat chamber (300). In the embodiment of FIG. 3 the heated gas in the first distribution chamber is all converted to the process gas entering the devolatilization chamber with none being recirculated. On the other hand, some of the heated gas in the second distribution chamber is not converted to process gas and is instead recirculated to the heat chamber.

The embodiment of FIG. 4 uses a belt to advance the solids along the devolatilization chamber (100). The belt could be perforated with the heated gas passing through the belt and becoming a process gas or the belt could be solid with the process gas passing primarily over the top of the solids on the belt.

FIG. 4 shows direct heating (320) with the exhaust gas (850) entering the atmosphere with the solids dropping off the end of the belt (170).

The embodiment of FIG. 5 shows two devolatilization process chambers using the same heat chamber. The first is the rotating devolatilization chamber which passes the solids to the second process chamber (1200). The solids are on the top of a perforated belt with heated gas coming underneath at an angle pointing towards the exit (170B). This fluidizes and moves the solids towards the exit.

Note that the two exhaust gases, 850A and 850B, may merge into a single exhaust gas (850).

The embodiment of FIG. 6 uses a cyclone (100) surrounded by the process chamber (500) to devolatilize the solids. The solids enter the top through the entrance (160). The heated gas (700) flows into the process chamber and then into the cyclone (devolatilization chamber) (100) and becomes a process gas (800). As the process gas passes in and around the solids, the volatiles are removed and then the process gas is exited out of the cyclone as exhaust gas (850).

The solids may advance through the cyclone (devolatilization chamber) by gravity (198, Fg).

The configuration of the motivation force is different as it pulls in the feed gas and mixes it with the recirculated gas at the heat source (320).

1-21. (canceled)

22. An apparatus (10) for devolatilizing a solid comprising:
a devolatilization chamber (100) having a devolatilization chamber volume (110), a devolatilization chamber first end (120), a devolatilization chamber second end (130) opposite the devolatilization chamber first end, a devolatilization chamber length (140), a devolatilization chamber wall (150) encompassing the devolatilization chamber volume defined by the devolatilization chamber wall, the devolatilization chamber first end and the devolatilization chamber second end, the devolatilization chamber further comprising a devolatilization chamber solids feed inlet (160) at the devolatilization chamber first end, and a devolatilization chamber solids discharge outlet (170) at the devolatilization chamber second end; a first distribution chamber inlet (210) at the devolatilization chamber first end which is fluidly connected to a first distribution chamber (200) located in the devolatilization chamber volume, with the first distribution chamber fluidly connected to a first distribution chamber outlet (220) located at the devolatilization chamber second end, with the first distribution chamber having at least one first distribution chamber port (230) for a heated gas (700) to pass from the first distribution chamber into the devolatilization chamber where the heated gas becomes a process gas (800);
a heat chamber (300) comprising a heat chamber volume (310) housing a heat source (320) with a feed gas inlet (330) into the heat chamber volume, a heated gas outlet (340), and a recirculated gas inlet (350); and
a motivation device (400) for removing the heated gas from the heat chamber to the distribution chamber inlet; and
wherein the heated gas outlet is fluidly connected with the first distribution chamber inlet and the first distribution chamber outlet is fluidly connected with the recirculated gas inlet;
the devolatilization chamber wall has a plurality of perforations (180) and is housed inside a process chamber (500) with the process chamber having at least one exhaust outlet (500, 510A, 510B) for the process gas to rise from the devolatilization chamber as an exhaust gas (850); and
a catch pan (520) to collect and remove at least one liquid (1000) and a plurality of particles falling from the devolatilization chamber.

23. The apparatus of claim 22, wherein the devolatilization chamber does not rotate about a longitudinal axis.

24. The apparatus of claim 22, wherein the devolatilization chamber is not inclined.

25. The apparatus of claim 22, wherein the devolatilization chamber wall has a configuration to advance a solid in the devolatilization chamber volume along the length of the devolatilization chamber while the devolatilization chamber is rotating.

26. The apparatus of claim 25, wherein the configuration comprises flights (190) extending from the devolatilization chamber wall into the devolatilization chamber.

27. The apparatus of claim 26, wherein the configuration further comprises paddles (195) between the flights.

28. The apparatus of claim 22, wherein the apparatus further comprises a second distribution chamber inlet (610) at the devolatilization chamber first end which is fluidly connected to a second distribution chamber (600) which is not located in the devolatilization chamber volume and is located within the process chamber, with the second distribution chamber having at least one second distribution chamber port (630) for the heated gas to pass from the second distribution chamber; and
wherein the heated gas outlet is fluidly connected with the second distribution chamber inlet.

29. The apparatus of claim 28 wherein the second distribution chamber is not fluidly connected with the recirculated gas inlet.

30. The apparatus of claim 22, wherein the apparatus is capable of advancing the solids through the devolatilization chamber using an advancement force provided by at least one of a rotating devolatilization chamber, an inclined devolatilization chamber, a belt passing through the devolatilization chamber, gravity, an angled heated gas into a perforated plate, and the heated gas being pulsed through a perforated plate.

31. The apparatus of claim 22, wherein the exhaust gas outlet is not fluidly connected with the heat chamber, the process chamber and the devolatilization chamber.

32. A process for devolatilizing solids comprising the steps of:
A. feeding a solid and at least one volatile to be removed from the solid into a devolatilization chamber (100);
B. heating a feed gas (900) and a recirculated gas (950) in a heating chamber (330) to create a heated gas (700) having a heated gas temperature;
C. creating the recirculated gas and a process gas (800) by distributing a portion of the heated gas into the devolatilization chamber containing the solids and the at least one volatile so that the heated gas becomes the process gas and is able to contact the solids with the remainder of the heated gas not distributed into the devolatilization chamber becoming the recirculated gas;
D. exhausting a portion of the process gas from the devolatilization chamber as an exhaust gas (850) so that no more than 50% by volume of the exhaust gas re-enters the heating chamber;
E. feeding at least a portion of the recirculated gas into the heat chamber; and
F. removing the solid from the devolatilization chamber.

33. The process of claim 32, wherein the heated gas temperature is less than a boiling point at atmospheric pressure of the volatile to be removed.

34. The process of claim 32, wherein no more than 0.1% by volume of the exhaust gas re-enters the heating chamber, the process chamber and/or the devolatilization chamber.

35. The process of claim 33, wherein no more than 0.1% by volume of the exhaust gas re-enters the heating chamber, the process chamber and/or the devolatilization chamber.

36. The process of claim 32, wherein none of the exhaust gas re-enters the heating chamber, the process chamber, and/or the devolatilization chamber.

37. The process of claim 33, wherein none of the exhaust gas re-enters the heating chamber, the process chamber, and/or the devolatilization chamber.
